(19) United States
(12) Patent Application Publication
(10) Pub. No.: US 2025/0230342 A1
(43) Pub. Date: Jul. 17, 2025

(54) SUSTAINABLE WATER ACTIVATED ADHESIVE TAPE

(71) Applicant: Intertape Polymer Corp., Sarasota, FL (US)

(72) Inventors: John K. Tynan, Port Huron, MI (US); John Cullen, Sarasota, FL (US); Nathan Isser, North Street, MI (US)

(73) Assignee: Intertape Polymer Corp., Sarasota, FL (US)

(21) Appl. No.: 19/170,913

(22) Filed: Apr. 4, 2025

Related U.S. Application Data
(63) Continuation of application No. 17/446,915, filed on Sep. 3, 2021.
(60) Provisional application No. 63/076,235, filed on Sep. 9, 2020.

(51) Int. Cl. C09J 7/32; B32B 5/02; B32B 27/10; B32B 27/30; B32B 29/02; B32B 37/15; B32B 37/20; C09J 7/29; C09J 7/50

(52) U.S. Cl. CPC C09J 7/32; B32B 5/02; B32B 27/10; B32B 27/306; B32B 29/02; B32B 37/153; B32B 37/203; C09J 7/29; C09J 7/50; B32B 2255/02; B32B 2255/10; B32B 2255/26; B32B 2260/021; B32B 2260/046; B32B 2262/02; B32B 2262/0223; B32B 2262/0276; B32B 2262/065; B32B 2262/101; B32B 2305/07; B32B 2307/7166; B32B 2315/08; B32B 2317/10; B32B 2317/122; B32B 2317/20; B32B 2329/04; B32B 2367/00; B32B 2371/00; B32B 2405/00; C09J 2301/304; C09J 2301/306; C09J 2400/143; C09J 2400/283; C09J 2403/00; C09J 2429/003; C09J 2429/006; C09J 2467/006; C09J 2471/006

(57) ABSTRACT

A water activated tape and method of producing is provided, the tape comprising a repulpable material, a water-soluble material affixed to the repulpable material, and a water activated adhesive layer affixed to the water-soluble material.

### CROSS-REFERENCE TO RELATED APPLICATIONS

This application is a continuation of U.S. patent application Ser. No. 17/446,915, filed Sep. 3, 2021 which claims the benefit of U.S. Provisional Application No. 63/076,235 filed on Sep. 9, 2020, the entirety of each of which is incorporated herein by reference.

### TECHNICAL FIELD

This disclosure is directed to a sustainable water activated adhesive tape. More specifically, the tape comprises a repulpable material, a water-soluble material adjacent the repulpable material, and a water activated adhesive layer adjacent the water-soluble material.

### BACKGROUND

Adhesive tapes for sealing cartons or carton flaps during manufacture or after the carton is filled are well known. For example, standard Kraft paper tape, which includes a water-activated adhesive on one side can be dispensed through machines which rely on the longitudinal stiffness of the tape to unwind it from the roll and force it through a tape moisturizing component. This component includes a water reservoir which moistens the adhesive surface of the tape and readies it for application to the carton. In previous attempts to meet differing requirements in the manufacture and sealing of cartons, multiple layered tapes using plastic films and/or reinforcing fibers generally made of fiberglass or other non-repulpable material were difficult to recycle and thus non-sustainable.

### SUMMARY

In a first example, a sustainable water activated adhesive tape is provided, the tape comprising a repulpable material layer, a water-soluble material adjacent the repulpable material layer, and a water activated adhesive adjacent the water-soluble material. In one aspect, the sustainable water activated adhesive tape is printable.

In one aspect, the repulpable material is cellulosic sheet. In another aspect, alone or in combination with any of the previous aspects, the cellulosic sheet is kraft paper.

In another aspect, alone or in combination with any of the previous aspects, the water-soluble material comprises a film comprising polyvinyl alcohol (PVOH). In another aspect, alone or in combination with any of the previous aspects, the PVOH is plasticized.

In another aspect, alone or in combination with any of the previous aspects, the water activated adhesive layer comprises starch, starch derivative or water-soluble heat activated adhesive.

In another aspect, alone or in combination with any of the previous aspects, the tape further comprises a reinforcing structure. In another aspect, alone or in combination with any of the previous aspects, the reinforcing structure comprises film, filament, yarn, or ribbon. In another aspect, alone or in combination with any of the previous aspects, the reinforcing structure is repulpable or non-repulpable. In another aspect, alone or in combination with any of the previous aspects, the film filament, yarn, or ribbon comprises PVOH.

In another aspect, alone or in combination with any of the previous aspects, the tape further comprises a third layer positioned between the water-soluble adhesive layer and the second layer, wherein the third layer comprises repulpable material.

In yet another example, a method of forming a sustainable water activated adhesive tape is provided, the method comprising contacting a bottom major surface of a repulpable material with a top major surface of a water-soluble material layer, and contacting a water activated adhesive to a bottom major surface of the water-soluble material.

In one aspect, the repulpable material is cellulosic sheet. In another aspect, the cellulosic sheet is kraft paper.

In one aspect, alone or in combination with any of the previous aspects, the water-soluble material layer comprises a film comprising polyvinyl alcohol (PVOH). In one aspect, alone or in combination with any of the previous aspects, the PVOH film is at least one of plasticized, machine direction oriented, or bi-directionally oriented.

In one aspect, alone or in combination with any of the previous aspects, the water activated adhesive comprises starch, starch derivative, or water-soluble heat activated adhesive.

In one aspect, alone or in combination with any of the previous aspects, the method further comprises introducing a reinforcing structure between the bottom major surface of the repulpable material layer and the water-soluble material layer, the reinforcing structure comprising non-water soluble film, filaments, yarns, or ribbons and/or water-soluble filaments, yarns, or ribbons. In one aspect, alone or in combination with any of the previous aspects, the reinforcing structure comprises PVOH, polyalkylene oxides, poly lactic acid, PET, glass fiber, or hemp.

In one aspect, alone or in combination with any of the previous aspects, the water-soluble adhesive material and the repulpable material are contacted by extrusion lamination, calendaring, or extrusion coating. In one aspect, alone or in combination with any of the previous aspects, the water-soluble material is configured as a cast or blown film and the method further comprises activating the cast or blown film and/or the repulpable material sheet.

### BRIEF DESCRIPTION OF THE DRAWINGS

In order to understand and to see how the present disclosure may be carried out in practice, examples will now be described, by way of non-limiting examples only, with reference to the accompanying drawings, in which:

FIG. 1 is a perspective view of a roll of tape for one aspect of the present disclosure.

FIG. 2 is a perspective view of a roll of tape corresponding to another aspect of the present disclosure.

FIG. 3 is an enlarged cross-sectional view of the tape of FIG. 1, taken along section line 2-2, illustrating an alternative configuration of layers.

FIG. 4 is an enlarged cross-sectional view of the tape of FIG. 2, taken along section line 4-4, illustrating the layers.

FIG. 5 is an enlarged cross-sectional view of the tape of FIG. 1, illustrating an alternative configuration of the layers.

FIG. 6 is an enlarged cross-sectional view of the tape of FIG. 2, illustrating an alternative configuration of the layers.

FIG. 7 depicts the tape of the present disclosure applied to a corrugated box.

FIG. 8 depicts a film/sheet lamination process aspect of the present disclosure.

FIG. 9 depicts a calender extrusion process aspect of the present disclosure.

FIG. 10 depicts an extrusion coating aspect of the present disclosure.

FIG. 11 depicts a film/sheet with a reinforcing structure lamination process aspect of the present disclosure.

FIG. 12 depicts a calender extrusion process aspect with reinforcing structure of the present disclosure.

FIG. 13 depicts an extrusion coating process aspect with reinforcing structure of the present disclosure.

### DETAILED DESCRIPTION

Previous attempts to add plastic films to water activated tapes, for example, as the layer to carry the water activated adhesive, have been inadequate and non-sustainable. The problem with this attempt is that the plastic film cannot hold a water activated adhesive effectively. In another previous attempt, plastic film was cold laminated to a paper backing using an adhesive to develop a tape where the plastic could be stripped away after application, however this attempt generates more waste. Neither previous attempts provide desired characteristics for sustainability in the packaging and shipping field.

The presently disclosed water activated adhesive tape eliminates or reduces some or all of the disadvantages of conventional (and reinforced) water activated adhesive structures that employ an polyolefin based or pressure sensitive adhesive and fiber glass, or polyethylene terephthalate (PET), reinforcing yarns, e.g., that are not sufficiently compatible with paper repulping and/or impede the downstream recycled paper-making process, if not filtered and removed from the pulp stream.

As used herein, the presently disclosed “water activated tape” (WAT) is inclusive of water activated tapes that resist or avoid prematurely dissolving when contacted by small amounts of water. For example, a WAT of the present disclosure when used to seal corrugated packages, will have a reduced tendency to fail as an adhesive after being contacted by small amounts of water. As used herein, the term “small amounts of water” refers to amounts of water that are less than sufficient to fully immerse the WAT, such as precipitation, and/or relatively high humidity environmental conditions.

As used herein, “repulpable” as used in the context of a material, is inclusive of a material substantially or completely derived from pulp. In one aspect, “repulpable material” is inclusive of a material capable of substantially or completely being turned into pulp again.

As used herein, “water-soluble” as used in the context of a material, filament, yarn or ribbon is inclusive of substantial or complete dissolution of the material, filament, yarn or ribbon in a repulping environment or process. In one aspect, as used herein, “water-soluble” as used in the context of a material, filament, yarn or ribbon is inclusive of substantial or complete dissolution of the material, filament, yarn or ribbon in an aqueous environment at a temperature of about 40-100° C. In another aspect, as used herein, “water-soluble” as used in the context of a material, filament, yarn or ribbon is inclusive of substantial or complete dissolution of the material, filament, yarn or ribbon in an aqueous environment of pH greater than 7.5 and a temperature of about 40-100° C.

As used herein, “derivatives” as used in the context of a material, is inclusive of a physical or chemical modification to the material, such as grafting, co-polymerization, blending, and/or exposing to high-energy radiation sources (i.e., crosslinking or chain scissoring).

In one example, the presently disclosed water activated adhesive tape provides an alternative to polyolefin adhesive or pressure sensitive adhesive with reinforcing yarns. In one example, the presently disclosed water activated adhesive tape provides a water activated adhesive tape with water-soluble or compostable reinforcing film, filaments, yarns, or ribbons.

Thus, in one example, the presently disclosed water activated adhesive tape comprises machine direction-oriented water-soluble film, filaments, yarns, or ribbons. In yet another example, the presently disclosed water activated adhesive tape comprises bi-directionally oriented water-soluble film, filaments, yarns or ribbons. In yet another example, the presently disclosed water activated adhesive tape comprises a reinforcing structure of water-soluble filaments, yarns, or ribbons, such as a scrim or web of intersecting filaments, yarns or ribbons thereof. The presently disclosed water activated adhesive tape with a reinforcing structure provides the paper laminate with structural strength and tear initiation and propagation resistance equivalent or superior to conventional adhesive/reinforcing yarn polyolefin based or pressure sensitive adhesive laminate tapes. Examples of machine direction-oriented or bi-directionally oriented water-soluble film, filaments, yarns or ribbons includes polyvinyl alcohol (PVOH), polyalkylene oxides, poly lactic acid and derivatives thereof.

In one example, the presently disclosed water activated adhesive tape comprises machine direction-oriented polyvinyl alcohol film, filaments, yarns, or ribbons (MD-PVOH). In yet another example, the presently disclosed water activated adhesive tape comprises bi-directionally oriented PVOH film, filaments, yarns, or ribbons (CMD-PVOH). In yet another example, the presently disclosed water activated adhesive tape comprises a reinforcing structure of PVOH film, filaments, yarns or ribbons, such as a scrim or web of intersecting filaments, yarns or ribbons thereof. The presently disclosed water activated adhesive tape with a reinforcing structure provides the paper laminate with structural strength and tear initiation and propagation resistance equivalent or superior to conventional adhesive/reinforcing yarn polyolefin adhesive or pressure sensitive adhesive laminate tapes.

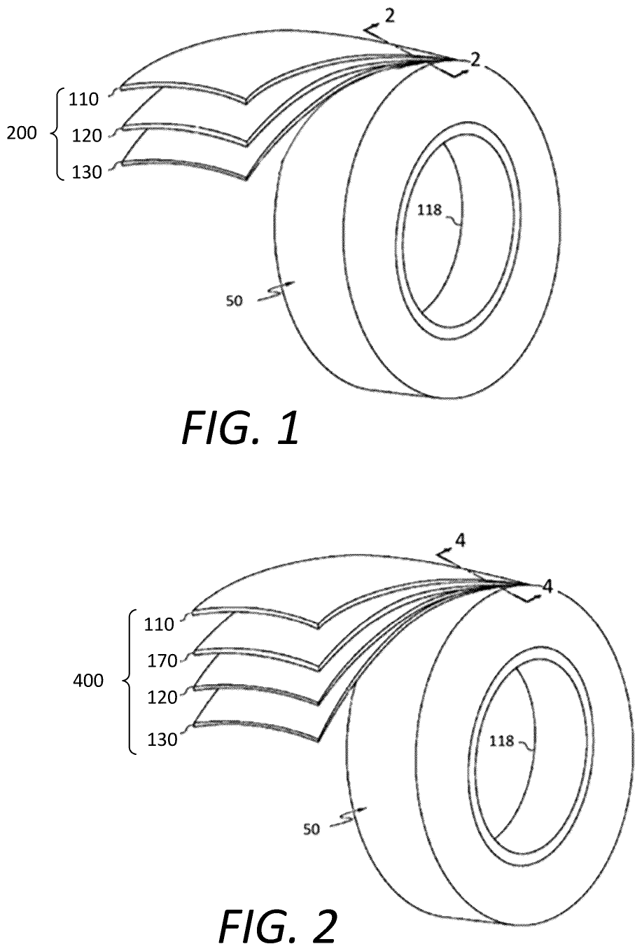

Thus, the disclosed water activated adhesive paper tapes are an improvement over previous packaging tapes using a plastic film and a water activated adhesive, as well as an improvement over previous packaging tapes using a plastic film, reinforcement, and a water activated adhesive. FIG. 1 illustrates a roll 50 of water activated adhesive tape 200,400 having water-soluble material layer 120 affixed to a repulpable material layer 110, and a water activated adhesive 130 affixed to water-soluble material layer 120 wound onto an optional core 118. In one example, core 118 is not present in the presently disclosed water activated adhesive paper tapes. FIG. 2 illustrates a roll 50 of water activated adhesive tape 400 having a reinforcement structure between paper layers 110 and water-soluble material layer 120, and a water activated adhesive 130 affixed to the water-soluble material layer 120, shown wound onto an optional core 118.

It shall be understood that the water activated adhesive tape 200, 400 as illustrated in FIGS. 1 and 2 are provided only to emphasize the individual layers of the tape and for purposes of describing the arrangement of layers thereof. It shall also be understood that the depicted individual layers of the water activated adhesive tape 200, 400 as illustrated in FIGS. 1 and 2, respectively, are essentially inseparable from each other without irreparably altering the structured layering of the tape.

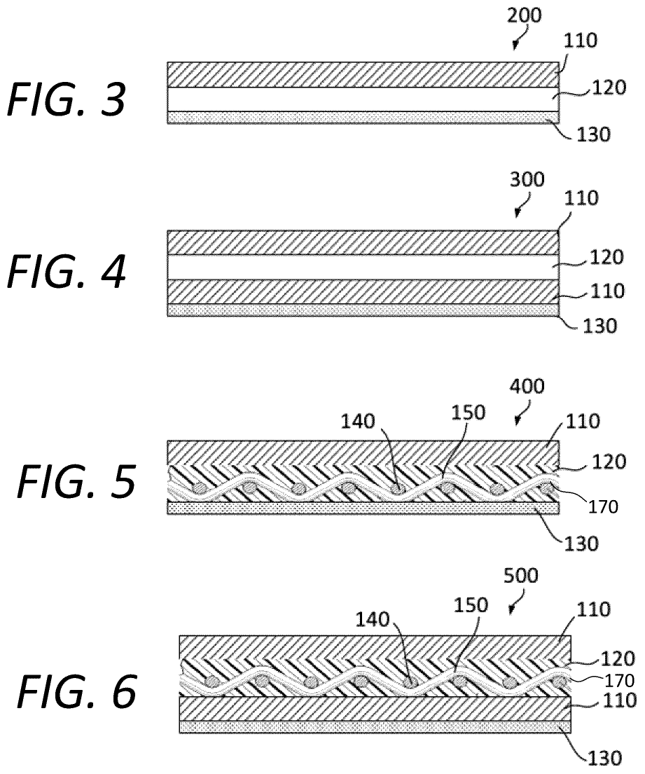

Referring to FIGS. 1 and 3, the water activated adhesive tape 200 includes a first layer affixed to a second layer. The first layer is a repulpable material layer 110. The second layer is a water-soluble material layer 120. The repulpable material layer 110 and the water-soluble material layer 120 both have, respectively, a first major (top) surface, a second major (bottom) surface, and a first side and a second side, whereas their respective first major surface and second major surface extend longitudinally essentially continuously for the length of the roll 50 of tape. Water activated tape 200 is shown with the first major (top) surface of water-soluble material layer 120 affixed to second major (bottom) surface of repulpable material layer 110. Affixed to the bottom surface of the water-soluble material layer 120 is the water activated adhesive 130. In one example, as illustrated by water activated adhesive tape 200, water activated adhesive 130 is applied directly to the water-soluble material layer 120 and not the repulpable material layer 110.

With reference to FIGS. 2 and 5, the water activated adhesive tape 400 includes a reinforcement structure 170 sandwiched between the water-soluble material layer 120 and repulpable material layer 110, with the water activated adhesive 130 affixed to the bottom major surface of water-soluble material layer 120. In one example, reinforcement structure 170 comprises machine-direction or bi-directionally oriented film, filaments, yarns, or ribbons. In another example, reinforcement structure 170 comprises film, yarns or ribbons 140,150. Yarns or ribbons 140 and 150 can be crosshatched, cross-laminated, or diagonally arranged relative to the major surface of the water-soluble material layer, for example to provide a scrim. In one example, reinforcement structure 170 is sufficiently porous to allow, by virtue of a melt laminate process, embedding of the water-soluble material layer 120 in the reinforcement structure 170, such that water-soluble material layer 120 is substantially presented for receiving water activated adhesive 130. In another example, water activated adhesive tape 400 has water activated adhesive 130 applied substantially to the water-soluble material layer 120 containing the reinforcement structure 170.

Referring now to FIGS. 4, alternative water activated adhesive tape 300 includes water-soluble material layer 120 sandwiched between two paper layers 110, and a water activated adhesive 130 applied to one of the bottom major surfaces of paper layers 110. The top surface of that repulpable material layer 110 is affixed to the water-soluble material layer 120. The water-soluble material layer 120 has its first major (top) surface, and second major (bottom) surface, sandwiched between and affixed to bottom major surfaces of paper layers 110. Applied to the bottom surface of one of the paper layers 110 is the water activated adhesive 130.

With reference to FIG. 6, the water activated adhesive tape 500 includes a reinforcement structure 170 sandwiched between water-soluble material layer 120, and the water-soluble material layer 120 is sandwiched between two repulpable material layers 110. Water activated adhesive 130 is affixed to bottom major surface of one of the repulpable material layers 110.

As used herein, “affixed” when used in the context of the repulpable material layer 110 and water-soluble material layer 120, include, but not limited to, extrusion coating, extrusion lamination, calender lamination, casting, and the like such that physical separation of the repulpable material layer 110 and water-soluble material layer 120 of the formed water activated tape irreparably alters the structural relationship between the layers thereof. Unless specifically indicated, “affixed” when used in the context of the repulpable material layer 110 and water-soluble material layer 120, excludes the use of a partial, continuous, or intermittent adhesive layer or of any adhesive material between the repulpable material layer 110 and the water-soluble material layer 120.

In one example, both the water-soluble material layer 120 and the repulpable material layer 110 are provided as sheet or film and/or brought together to form a laminate. In one example, a sheet paper with water activated adhesive 130 affixed thereto is laminated to the water-soluble material layer 120. In one example, the water-soluble material layer 120 is a cast or blown film. In another example, the water-soluble material layer 120 and/or the repulpable material layer 110 is activated prior to forming the laminate. In one example, the top major surface of the water-soluble material layer 120, or the bottom major surface of the repulpable material layer 110 can be activated prior to producing the paper/water-soluble material layer laminate. Suitable activation processes include corona discharge, flame treatment, spray or spot coating adhesive or using coupling agents such as polyamines, amino silanes, amino siloxanes and the like. In one example, activating either the water-soluble material layer 120 or the repulpable material layer 110 is performed with brief exposure to water, steam, or other aqueous or humid conditions just prior to affixing the layers 110, 120 together.

In one example, the water-soluble material layer 120 is heated to a softened and/or melted state and extrusion coated, cast or calendered extruded to a bottom major surface of the repulpable material layer 110. Water activated adhesive 130 is subsequently applied to the bottom major surface of the water-soluble material layer 120.

The water activated adhesive tape 200, 400, as a result of the film/sheet joining, extrusion coating/casting/calendering of the water-soluble material layer 120 to the repulpable material layer 110, the cellulosic layer is not easily strippable or separated therefrom. That is, once the cellulosic layer is coated, it is not easy, if not impossible without significant loss of structural integrity, to separate the repulpable material layer 110 from the water-soluble material layer 120.

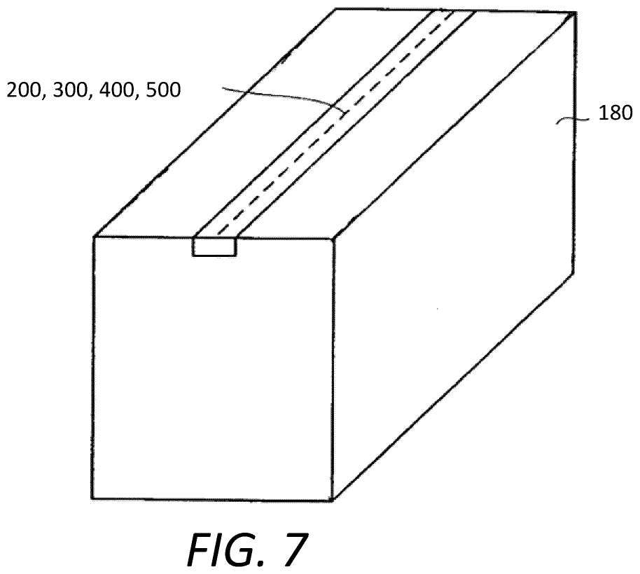

FIG. 7 illustrates a corrugated box 180 having the presently disclosed water activated adhesive tape 200,300,400,500 providing means for closure of the corrugated box. The presently disclosed water activated adhesive tape 200,300,400,500 is configured to be dispensable and/or the water activated adhesive activated using known water activated adhesive tape dispensing equipment. In one example, the presently disclosed water activated adhesive tape configured to be dispensable using known water activated adhesive tape dispensing equipment without any additional modification to the dispensing equipment.

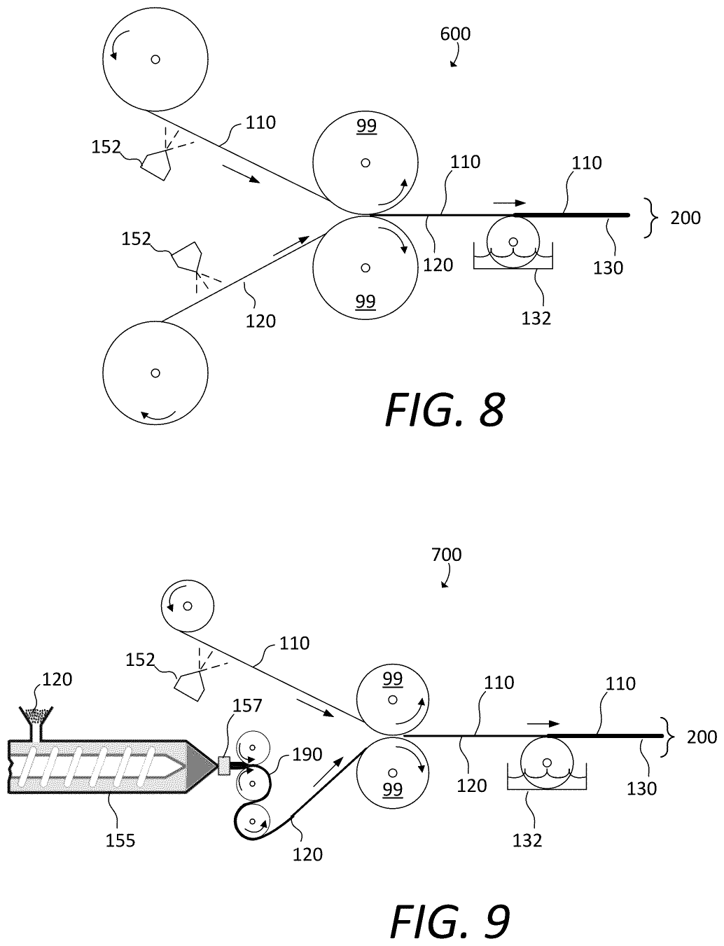

Regarding FIG. 8, an exemplary process 600 for providing the water activated adhesive tape 200 of the present disclosure is shown. Bottom major surface of repulpable material layer 110, for example, provided as a sheet, is affixed to top major surface of water-soluble material layer 120, for example, provided as a sheet or film, e.g., blown or cast sheet or film. In one example, the bottom major surface of repulpable material layer 110 and/or the top major surface of water-soluble material layer 120 are activated prior to introduction to nip rolls 99 via activating units 152. In one example, bottom major surface of repulpable material layer 110 and/or top major surface of water-soluble material layer 120 are activated using an aqueous composition in activating unit 152. In one example, the aqueous composition is water and/or alcohol. Other activating agents can be employed. After bottom major surface of repulpable material layer 110 and top major surface of water-soluble material layer 120 are fixed to each other, the laminate can be taken up into a roll form for further processing or can be continuously processed as shown in FIG. 8 to apply water activated adhesive 130 to bottom major surface of water-soluble material layer 120. Application of water activated adhesive 130 can be provided using conventional water activated adhesive coating methods, such as, roll-over-roll, reverse roll, multi-roll-coaters, a slot die, a proximity die, a Mayer rod, curtain coating, gravure coating, reverse gravure coating, knife-over-roll, and the like. As shown in FIG. 8, water activated adhesive 130 application to the bottom major surface of water-soluble material layer 120 is shown by example using roll coating from reservoir 132 and thereafter winding the tape onto a roll and slitting the rolled tape into a plurality of rolls of water activated tape.

With reference to FIG. 9, another exemplary process 700 for providing the water activated adhesive tape 200 of the present disclosure is provided. Bottom major surface of repulpable material layer 110, for example, provided as a sheet is affixed to top major surface of water-soluble material layer 120, provided from extruder 155 through a die 157 to a plurality of calender rolls 190 for providing a cast or calendered sheet of water-soluble material layer 120. In one example, bottom major surface of repulpable material layer 110 and/or top major surface of water-soluble material layer 120 are activated prior to introduction to nip rolls 99. In one example, bottom major surface of repulpable material layer 110 is activated via activating units 152 using an aqueous composition, e.g., water and/or alcohol. Other activating agents can be employed such as plasma treatment, corona discharge, flame treatment. After bottom major surface of repulpable material layer 110 and top major surface of water-soluble material layer 120 are fixed to each other, the laminate can be taken up into a roll form for further processing or can be continuously processed as shown in FIG. 9 to apply water activated adhesive 130 to bottom major surface of water-soluble material layer 120 using conventional water activated adhesive coating methods and thereafter winding the tape onto a roll and slitting the rolled tape into a plurality of rolls of water activated tape.

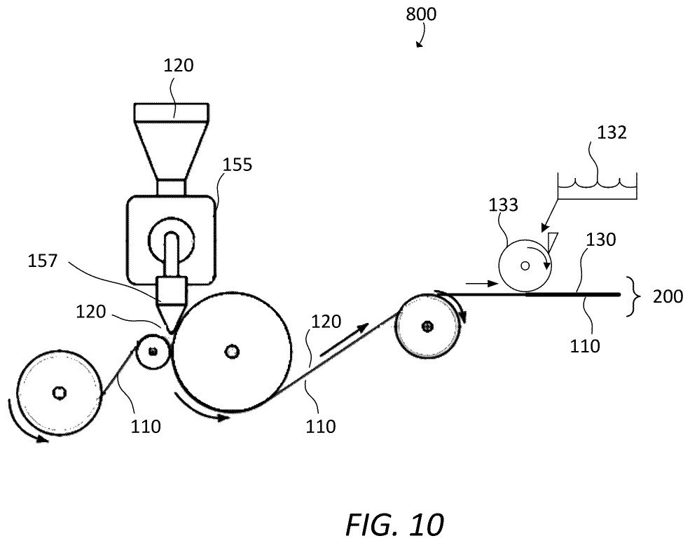

With reference to FIG. 10, another exemplary process 800 for providing the water activated adhesive tape 200 of the present disclosure is provided. Bottom major surface of repulpable material layer 110, for example, provided as a sheet, is extrusion coated with water-soluble material layer 120 from extruder 155 through a die 157. After bottom major surface of repulpable material layer 110 and top major surface of water-soluble material layer 120 are affixed to each other, the laminate can be taken up into a roll form for further processing or can be continuously processed as shown in FIG. 10 to apply water activated adhesive 130 to bottom major surface of water-soluble material layer 120 using conventional water activated adhesive coating methods e.g., blade coating 133 via reservoir 132, as described above, and thereafter winding the tape and slitting the rolled tape into a plurality of rolls of water activated tape.

The extrusion laminating disposes the innermost lamination layer contiguous to the bottom major surface of the paper and the water-soluble fibers. The method can also include extrusion coating the water-soluble film and the water-soluble fibers together and laminating the construct onto the repulpable material layer 110, an applying the water activated adhesive 130. The water activated adhesive 130 can be presented as a continuous, semi-continuous, or discontinuous layer.

While the water activated adhesive tapes 200 described above reduces or eliminates the need for a filament scrim reinforcement layer and only one cellulosic layer, in other examples, water activated adhesive tape of the present disclosure includes a reinforcement structure for providing a tape product with uniform puncture and tear properties as well as producing a thinner tape that will provide more length for a given roll diameter, and/or requiring fewer roll changes on applicating equipment. In one example, the reinforcement structure includes water-soluble film and water-soluble filaments, yarns, or ribbon in combination.

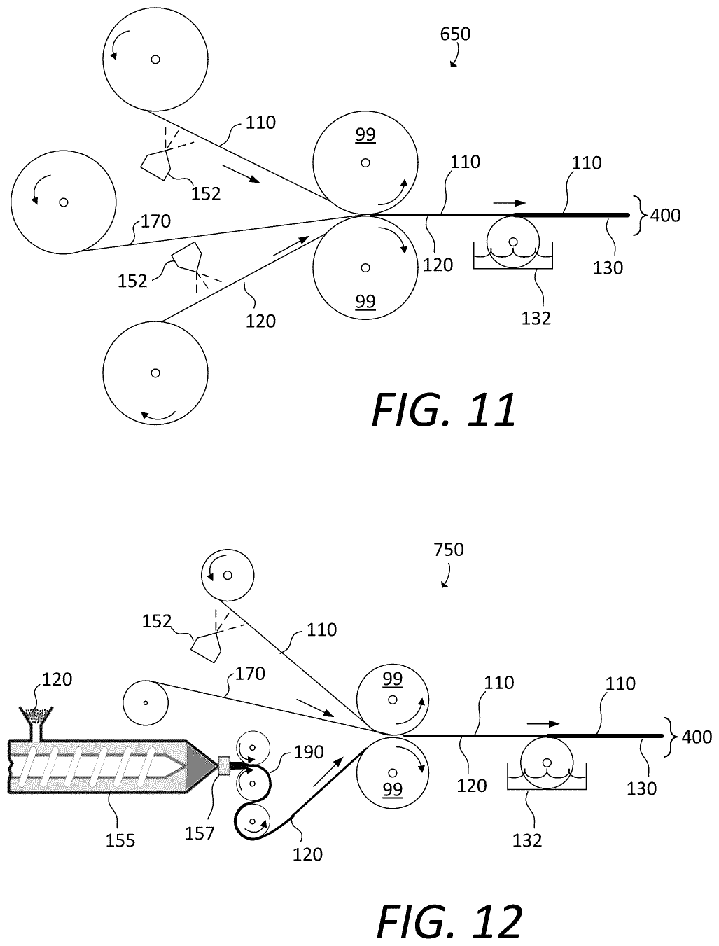

In one example, the reinforcement structure comprises a sustainable reinforcement structure 170. Thus, regarding FIG. 11, an exemplary process 650 of producing presently disclosed water activated tape 400 a shown. Bottom major surface of repulpable material layer 110, for example, provided as a sheet is affixed to top major surface of water-soluble material layer 120, for example, provided as a sheet or film, e.g., blown or cast film with reinforcement structure 170 sandwiched in between. Reinforcement structure 170 can be provided as a web (e.g., a diagonally crosshatched web) or can be provided as machine-direction oriented fibers, filaments, yarn or ribbon introduced via a beam or creel, or as cross machine-direction fibers.

In one example, the bottom major surface of repulpable material layer 110 and/or the top major surface of water-soluble material layer 120 are activated prior to introduction to nip rolls 99 as described above. After bottom major surface of repulpable material layer 110 and top major surface of water-soluble material layer 120 are affixed to each other with reinforcement structure 170, the laminate can be taken up into a roll form for further processing or can be continuously processed as shown in FIG. 11 to apply water activated adhesive 130 to bottom major surface of water-soluble material layer 120. In one example, water activated adhesive 130 is presented substantially to the water-soluble material layer 120. In another example, water activated adhesive 130 is presented to reinforcement structure 170 as well as water-soluble material layer 120 depending on the porosity of the reinforcement web and/or thickness of the water-soluble material layer, among other things. Application of water activated adhesive 130 can be provided using conventional water activated adhesive coating methods, such as, roll-over-roll, reverse roll, multi-roll-coaters, a slot die, a proximity die, a Mayer rod, gravure coating, reverse gravure coating, knife-over-roll, and the like. As shown in FIG. 11, water activated adhesive 130 application to the bottom major surface of water-soluble material layer 120 is shown by example using roll coating from reservoir 132.

With reference to FIG. 12, another exemplary process 750 for providing the water activated adhesive tape 400 of the present disclosure is provided. Bottom major surface of repulpable material layer 110, for example, provided as a sheet sandwiches reinforcement structure 170 with top major surface of water-soluble material layer 120, provided from extruder 155 through a die 157 to calendar roll 190 that provides a cast or calendered sheet. In one example, bottom major surface of repulpable material layer 110 and/or top major surface of water-soluble material layer 120 are activated prior to introduction to nip rolls 99 as described above. After bottom major surface of repulpable material layer 110 and top major surface of water-soluble material layer 120 are configured to sandwich reinforcement structure 170, the laminate can be taken up into a roll form for further processing or can be continuously processed as shown in FIG. 12 to apply water activated adhesive 130 to bottom major surface of water-soluble material layer 120 using conventional water activated adhesive coating methods.

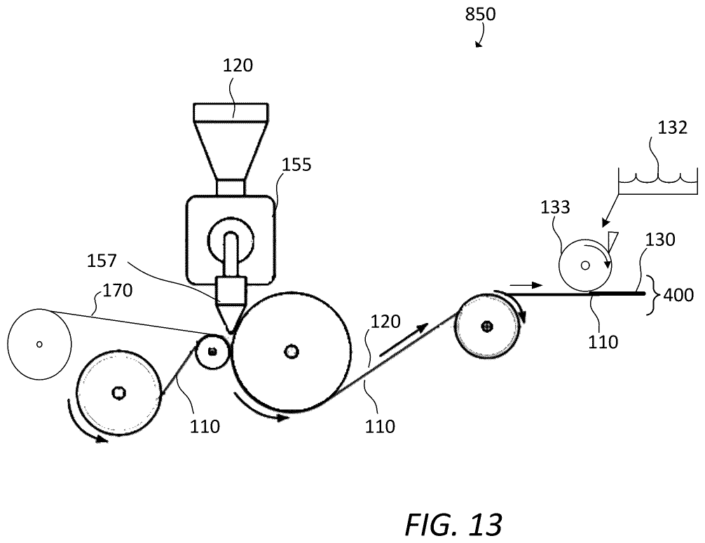

With reference to FIG. 13, another exemplary process 850 for providing the water activated adhesive tape 400 of the present disclosure is provided. Bottom major surface of repulpable material layer 110, for example, provided as a sheet, is extrusion coated from extruder 155 through a die 157 so as to sandwich reinforcement structure 170 between top major surface of water-soluble material layer 120 and bottom major surface of repulpable material layer 110. In an alternate aspect, reinforcing structure can be co-extruded with water-soluble material prior to contacting with the repulpable material. After bottom major surface of repulpable material layer 110 and top major surface of water-soluble material layer 120 are affixed to each other with reinforcement structure 170 sandwiched therebetween, the laminate can be taken up into a roll form for further processing or can be continuously processed as shown in FIG. 13 to apply water activated adhesive 130 to bottom major surface of water-soluble material layer 120 using conventional water activated adhesive coating methods e.g., blade coating 133 via reservoir 132, or as described above, and thereafter winding the tape and slitting the rolled tape into a plurality of rolls of water activated tape.

Additives for inclusion in the extrusion coating or extrusion lamination process or for the water activated tape itself, can include one or more of ultraviolet (UV) inhibitors, antioxidants, pigments, fillers, and antistatic agents, but are not limited thereto.

Repulpable material layer 110 may be any type of repulpable material, such as cellulosic material. In another example, repulpable material layer 110 is printable. Printable as used herein is inclusive of flexographic printing, water or solvent based printing, inkjet printing, conductive or electrostatic printing and thermal or thermal transfer printing methods. Examples of cellulosic materials include paper, such as, but not limited to, creped paper, non-creped paper, or release paper. In one example, the repulpable material layer 110 is a Kraft paper. In another example Creped NBSK (Northern Bleached Softwood Kraft) paper web is used. In one example, a 20 to 57 lb Kraft paper is used. In one example, the repulpable material layer 110 is treated with a hydrophobic coating. Examples of hydrophobic coatings include, for example, hydrogenated triglycerides of a carbon-chain-length of about 10-20, lacquer, synthetic or natural wax, and the like, so as to resist alteration or degradation from exposure to precipitation and other expected environmental conditions experienced by a packaging or shipping tape.

The water-soluble material layer 120 can be any water-soluble polymeric film mono- or multi-layer with sufficient tensile and tear properties to function as a tape for sealing corrugated boxes. In one example, suitable PVOH polymer films useful in the practice of the present disclosure in forming a sustainable water activated adhesive tape have 12-18% crystallinity and is 70% or more hydrolyzed. In another example a suitable PVOH polymer has 30-50% crystallinity and is 80%, 90%, or 99% or more hydrolyzed. In one example, water-soluble films of the present disclosure can be any one or more of commercially available products, for example: 73% hydrolyzed PVOH, Kuraray Poval 505, number average molecular weight 28,000, 88% hydrolyzed PVOH Kuraray Poval 205, Nippon Gohsei GL05, 98% hydrolyzed PVOH, Nippon Gohsei N-300. Polyethylene/Polyvinyl Alcohol Terpolymer, and EXCEVAL (Kuraray LTD of Japan).

The water activated adhesive 130 can be presented to the tape as a continuous or discontinuous film, applied dry or as a solution, such as by spray or electrostatic coating. The water activated adhesive 130 as may be any conventional water activated adhesive or hereinafter developed adhesive suitable for box sealing or carton sealing tapes (also referred to as packaging tapes). In one example, the water activated adhesive 130 can be a starch or starch derivative. In one example, the starch, starch derivative or thermoplastic starch is derived from corn, sorghum, wheat, sago, tapioca, legumes, barley, rice, and/or potatoes. In one example, the starch or starch derivative comprises maize, waxy maize, wheat, potato, tapioca, or mixtures thereof.

In another example, the water activated adhesive 130 is a starch derivative. Examples of starch derivatives include, but are not limited to starch in combination with or reacted with polyacrylates (e.g., polyethylacrylate, polypropylacrylate), polymethacrylates (for example, polyethylmethacrylate or polypropylmethacrylate), polyacrylic acid, acrylic acid, acrylamide, acrylonitrile, copolymers of acrylic acid (for example, ethylene/acrylic-acid-copolymer, ethylene/butylene/acrylic acid copolymer, butylene acrylic acid copolymer), methacrylic-acid copolymers (for example, ethylene/methacrylic-acid copolymer, polyethylene/vinylacetate) and mixtures thereof.

In another example, the water activated adhesive 130 is a hot water-soluble, heat activatable adhesive based on an at least, polyethylenvinylalcohol, polyacrylates (e.g., polyethylacrylate, polypropylacrylate), polymethacrylates (for example, polyethylmethacrylate or polypropylmethacrylate), polyacrylic acid, copolymers of acrylic acid (for example, ethylene/acrylic-acid-copolymer, ethylene/butylene/acrylic acid copolymer, butylene acrylic acid copolymer), methacrylic-acid copolymers (for example, ethylene/methacrylic-acid copolymer, polyethylene/vinylacetate) and mixtures thereof.

The water activated adhesive 130 may be applied to the repulpable material layer 110 or the water-soluble material layer 120 as a solvent-cast, solventless, or molten film or as a coating layer using either extrusion, any manner of roll, knife, rod, or blade coating, curtain coating or any suitable application method. In one example, the water activated adhesive 130 is present at a thickness of about 0.1 mil to about 2.5 mil. In one example, the water activated adhesive 130 substantially or completely excludes pressure sensitive adhesive (PSA).

Polyvinyl alcohol (PVOH) as used herein can be partially or fully hydrolyzed, where PVOH is a synthetic resin generally prepared by t hydrolysis or saponification of polyvinyl acetate. Both fully and partially hydrolyzed PVOH (also referred to as a vinyl alcohol-vinyl acetate copolymer) may be employed in the practice of the present disclosure.

As a representative exemplary example of a water-soluble film suitable for practicing the present disclosure, PVOH or PVOH derivative films (collectively “PVOH films”) are described. PVOH films are produced via melt extrusion and solution casting methods, for example. Typically, in both processes, a highly crystalline PVOH is mixed with a plasticizer to reduce the total amount of crystallinity of the finished, water activated adhesive soluble film.

In one example, incorporation of high molecular weight plasticizers with the PVOH film reducing large crystalline regions within the film, and/or incorporation of low weight plasticizers reducing the small crystalline regions are used. The plasticizer system can be one, or a combination of conventional plasticizers including polyhydric alcohols, waxes, hydrocarbon oil, mineral oil, polyethylene glycol, propylene glycol, polyethylene oxide, polypropylene oxide, glycerine, mannitol, pentaerythritol, trimethylpropane, starch, chitosan, erythritol, polyethylene amines, ethanolamines, and ionic polymers. Additional components can be added to the PVOH for processing such as nucleating agents, anti-caking agents, anti-slip agents, fillers, such as calcium carbonate, organic and inorganic salts, and the like.

PVOH derivatives include, for example, PVOH blends or copolymers. The PVOH blends or copolymers, for example, can contain at least about 50 wt. %, 55 wt. %, 60 wt. %, 65 wt. %, 70 wt. %, 75 wt. %, 80 wt. %, 85 wt. %, or 90 wt. % and/or up to about 60 wt. %, 70 wt. %, 80 wt. %, 90 wt. %, 95 wt. %, or 99 wt. % of the PVOH. Blends of PVOH can include PVOH polymers of different viscosity, different average molecular weight, different vinyl acetate content, and/or different crystallinity as measured by direct scanning calorimetry (DSC). PVOH blends can include other water-soluble materials, for example, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum, polyacrylates and water-soluble acrylate copolymers, methylcellulose, carboxymethyl cellulose salts (e.g., sodium carboxymethyl cellulose, calcium carboxymethyl cellulose), dextrin, ethylcellulose, ethylhydryoxyethyl cellulose (EHEC), hydroxyethyl cellulose (HEC), hydroxyethylmethyl cellulose (HEMC), hydroxypropyl cellulose (HPC), hydroxypropyl methyl cellulose (HPMC), maltodextrin, methyl cellulose (MC), polymethacrylates, and copolymers of PVOH, and mixtures thereof.

Copolymers of PVOH includes polymers that are derived by the hydrolysis of a copolymer of a vinyl ester, typically vinyl acetate, and another monomer. Copolymers of PVOH include, for example, one or more carboxylic monomer units, or one or more anionic monomers units, for example, acrylamido methylpropanesulfonic acids (e.g., AMPS comonomers such as 2-acrylamido-1-methylpropanesulfonic acid, 2-acrylamido-2-methylpropanesulfonic acid, 2-methylacrylamido-2-methylpropanesulfonic acid), alkali metal salts thereof (e.g., sodium salts), and combinations thereof. Blends of PVOH and its copolymers as described above can be used.

In one example, extruded films of the aforementioned PVOH polymers or copolymers produced from 98-99.9% hydrolyzed polyvinyl acetate function similarly to EXCEVAL, can be used. Such extruded films exhibit dissolution in water at 60° C., rather than 80° C., for example. If desired, the PVOH can be compounded into a thermoplastic pellet with a suitable film being produced therefrom via melt extrusion. In one example, the PVOH used to make extrudable pellets has less than 0.5% sodium acetate present and/or the extrudable pellets are dried to a level of less than 2% moisture prior to film formation.

In one example, reinforcement structure 170 is used in the presently disclosed water activated tape. Reinforcement structure 170 can comprise film, filaments, yarns, or ribbons 140 and 150 that are non-soluble and/or non-repulpable. Non-soluble and/or non-repulpable film, filaments, yarns, or ribbons include, for example, glass, polyethylene terephthalate (PET), hemp, and the like.

In another example, reinforcement structure 170 comprises film, yarns or ribbons 140 and 150 that are water-soluble and/or re-pulpable. Examples of water-soluble and/or re-pulpable yarns or ribbons can include cellulosic fibers, hemp, or water-soluble polymers, for example, polyvinyl alcohol (PVOH), polyalkylene oxides, poly lactic acid, and the like. In one example, yarns or ribbons 140,150 of reinforcement structure 170 are water-soluble polymeric film, filaments, yarns, or ribbons comprising PVOH or PVOH copolymers.

As a result of the construction of the presently disclosed water activated adhesive tape 200,300,400,500, the presently disclosed tape can remain with the corrugated carton through paper recycling and re-pulping processes with little if any negative impact to operational processes of repulping or downstream new paper-making processes. The presently disclosed water activated adhesive tape possesses the physical and structural attributes of a traditional water activated adhesive carton sealing tape, for example, the ability to be printed, the ability to form a tamper-evident “weld” with the corrugated carton, i.e., once the water activated adhesive's glue has been activated and subsequently applied to the corrugated carton, to pass International Save Transit Association (ISTA) 3A drop testing, and be at least 75%, at least 80%, at least 90%, or at least 95-99% (by weight) re-pulpable, as measured by the Fiber Box Association's (FBA) re-pulpability test method. Moreover, at least 75%, at least 80%, at least 90%, or at least 95-99% of the weight of the water activated tape presently disclosed is available for recycling, e.g., making recycled paper.

While certain embodiments of the present disclosure have been illustrated with reference to specific combinations of elements, various other combinations may also be provided without departing from the teachings of the present disclosure. Thus, the present disclosure should not be construed as being limited to the particular exemplary embodiments described herein and illustrated in the Figures, but may also encompass combinations of elements of the various illustrated embodiments and aspects thereof.

We claim:

1. A sustainable water activated adhesive tape comprising:
a repulpable material layer;
a water-soluble material layer adjacently affixed to the repulpable material layer; and
a water activated adhesive adjacently affixed the water-soluble material layer.

2. The sustainable water activated adhesive tape of claim 1, wherein the repulpable material layer is cellulosic sheet.

3. The sustainable water activated adhesive tape of claim 1, wherein the repulpable material layer is kraft paper sheet.

4. The sustainable water activated adhesive tape of claim 1, wherein the water-soluble material layer comprises a film comprising polyvinyl alcohol (PVOH).

5. The sustainable water activated adhesive tape of claim 4, wherein the film comprising PVOH is at least one of plasticized, machine direction oriented, or bi-directionally oriented.

6. The sustainable water activated adhesive tape of claim 1, wherein the water activated adhesive layer comprises starch, starch derivatives, or heat activated adhesive.

7. The sustainable water activated adhesive tape of claim 1, further comprising a reinforcing structure comprising film, filament, yarn, or ribbon.

8. The sustainable water activated adhesive tape of claim 7, wherein the reinforcing structure comprises film, filament, yarn or ribbon comprising PVOH, polyalkylene oxides, poly lactic acid, glass fiber, or hemp.

9. The sustainable water activated adhesive tape of claim 1, further comprising a reinforcing structure positioned between the water-soluble adhesive layer and the water-soluble material layer.

10. A corrugated box comprising the sustainable water activated adhesive tape as defined in claim 1.

11. A method of forming a sustainable water activated adhesive tape comprising:
contacting a bottom major surface of a repulpable material with a top major surface of a water-soluble material; and
contacting a water activated adhesive to a bottom major surface of the water-soluble material.

12. The method of claim 11, wherein the repulpable material is a paper sheet.

13. The method of claim 12, wherein the paper sheet is kraft paper.

14. The method of claim 11, wherein the water-soluble material comprises a film comprising polyvinyl alcohol (PVOH).

15. The method of claim 14, wherein the PVOH is plasticized.

16. The method of claim 15, wherein the water activated adhesive comprises starch, starch derivatives, or heat activated adhesive.

17. The method of claim 11, further comprising introducing a reinforcing structure between the bottom major surface of the repulpable material and the water-soluble material, the reinforcing structure comprising, alone or in combination: non-soluble compostable sustainable film, filaments, yarns, or ribbons; and water-soluble film, filaments, yarns, or ribbons.

18. The method of claim 17, wherein the reinforcing structure comprises PVOH, polyalkylene oxides, poly lactic acid, glass fiber, or hemp.

19. The method of claim 11, wherein the repulpable material and the water soluble material are contacted by extrusion lamination, calendaring, or extrusion coating.

20. The method of claim 11, wherein the water-soluble material is configured as a cast or blown film and the method further comprises activating the cast or blown film and/or the repulpable material with an aqueous composition, plasma, or flame treatment.
